(19) United States
(12) Patent Application Publication
(10) Pub. No.: US 2025/0031291 A1
(43) Pub. Date: Jan. 23, 2025

(54) LED LAMP WITH GOOD DYNAMIC EFFECT

(71) Applicants: QINGBIAO WU, Fujian (CN); LINLIN WU, Fujian (CN)

(72) Inventors: QINGBIAO WU, Fujian (CN); LINLIN WU, Fujian (CN)

(21) Appl. No.: 18/241,223

(22) Filed: Aug. 31, 2023

(30) Foreign Application Priority Data
Jul. 20, 2023 (CN) 2023219154792

(51) Int. Cl. H05B 45/37; F21K 9/232; F21K 9/238

(52) U.S. Cl. CPC H05B 45/37; F21K 9/232; F21K 9/238

(57) ABSTRACT

An LED lamp with a good dynamic effect, having a lamp body and a photoelectric circuit; an empty cavity is formed inside the lamp body; the photoelectric circuit is installed in the empty cavity; the photoelectric circuit comprises a power supply input end, an alternating current/direct current management circuit, a light-emitting power supply circuit and a light-emitting assembly; the lamp body is internally provided with a PCB board; the power supply input end, the alternating current/direct current management circuit, the light-emitting power supply circuit and the light-emitting assembly are respectively arranged on the PCB board.

### FIELD OF THE INVENTION

The present invention relates to the technical field of decorative illumination and more particularly pertains to an LED lamp with a good dynamic effect.

### BACKGROUND OF THE INVENTION

In recent years, due to the general improvement of people's living standards, decorative light bulb strings, which used to be widely used in large number for festive decorative purposes, have gradually been widely used in a variety of commercial promotional venues or public spaces for decoration and beautification purposes, and thus there is a tendency for expansion of the market demand.

However, existing dynamic LED lamp strips generally consist of a plurality of LED lamp beads connected in series; the LED lamp strips are also equipped with control chips; they are applied to relatively larger space with complicated structures, so they have high production costs and low cost performance, and are not conducive to the market demand for promoting the application in relatively smaller space.

In view of the above, the Applicant conducted an in-depth research of the problem described above, which results in the present invention.

### BRIEF SUMMARY OF THE INVENTION

It is an object of the present invention to provide an LED lamp which has simple structure, low costs, good dynamic effect, and can be applied to relatively smaller space.

To fulfill the above objects, the present invention adopts the following technical solutions:

An LED lamp with a good dynamic effect comprises a lamp body and a photoelectric circuit; an empty cavity is formed inside the lamp body; the photoelectric circuit is installed in the empty cavity; the photoelectric circuit comprises a power supply input end, an alternating current/direct current management circuit, a light-emitting power supply circuit and a light-emitting assembly; the alternating current/direct current management circuit comprises a resistance-capacitance step-down assembly and a rectifier;
the power supply input end has a first power supply end and a second power supply end; the resistance-capacitance step-down assembly has a first resistance-capacitance step-down assembly end and a second resistance-capacitance step-down assembly end; the rectifier has a first rectifier end, a second rectifier end, a third rectifier end and a fourth rectifier end; the light-emitting power supply circuit has a first light-emitting power supply circuit end and a second light-emitting power supply circuit end; the light-emitting assembly has a first light-emitting assembly end and a second light-emitting assembly end;
the first power supply end is electrically connected with the first resistance-capacitance step-down assembly end; the second power supply end is electrically connected with the third rectifier end; the second resistance-capacitance step-down assembly end is electrically connected with the first rectifier end; the first light-emitting power supply circuit end is electrically connected with the second rectifier end; the second light-emitting power supply circuit end is electrically connected with the fourth rectifier end; the first light-emitting assembly end is electrically connected with the second rectifier end; the second light-emitting assembly end is electrically connected with the fourth rectifier end;
the lamp body is internally provided with a PCB board; the power supply input end, the alternating current/direct current management circuit, the light-emitting power supply circuit and the light-emitting assembly are respectively arranged on the PCB board.

Preferably, the light-emitting assembly internally comprises a control chip and a plurality of LED chips connected with each other; the control chip is a program for programmably driving the plurality of LED chips to emit light; the plurality of LED chips are connected with the control chip and packaged into a long strip-shaped lamp filament, and the long strip-shaped lamp filament has a length which corresponds to size of the empty cavity formed inside the lamp body.

Preferably, the resistance-capacitance step-down assembly comprises a resistor R2 and a capacitor C1 connected in parallel with each other.

Preferably, the resistance-capacitance step-down assembly further comprises a resistor R1; the resistor R1 is connected in series with the parallel connected resistor R2 and capacitor C1.

Preferably, the light-emitting power supply circuit comprises a capacitor C2 and a zener diode connected in parallel with each other.

Preferably, the first power supply end and the second power supply end together form a power supply end of the lamp body, and the power supply end is connected with an external power supply.

Preferably, the resistor R1 is a resistor assembly comprising at least two sequentially connected resistors R1.

Preferably, the lamp body comprises a lampshade and a lamp holder connected with the lampshade; the empty cavity is formed in the lamp body when the lampshade and the lamp holder are connected with each other.

Preferably, the PCB board is installed in an upper portion of the empty cavity; the power supply input end, the alternating current/direct current management circuit, the light-emitting power supply circuit and the light-emitting assembly of the photoelectric circuit are arranged on the PCB board.

According to the above technical solutions, the present invention has the following beneficial effects:

The voltage division is realized through the resistance-capacitance step-down assembly, the rectifier converts alternating current mains power into a low-voltage direct current and supplies stabilized voltage power to the light-emitting assembly through the light-emitting power supply circuit, so that the long strip-shaped lamp filament is programmed to light up. In the present invention, the carrier technology is adopted to realize the carrier modulation of signals and power supply and the power line carrier data transmission, and step-by-step delivery and step-by-step control can be performed, so that the meteor light effect of the present invention can be ensured while the photoelectric circuit is installed in the limited space of the lamp body.

### BRIEF DESCRIPTION OF THE DRAWINGS

FIG. 1 is a schematic circuit diagram of the photoelectric circuit according to the present invention;

FIG. 2 is a schematic view of the resistor assembly of the present invention; and

FIG. 3 is a disassembling view of the present invention

Denotations in the figures: lamp body 1, lampshade 11, lamp holder 12, empty cavity 13, first power supply end 14, second power supply end 15, photoelectric circuit 2, power supply input end 21, alternating current/direct current management circuit 22, resistance-capacitance step-down assembly 221, rectifier 222, resistor assembly 223, light-emitting power supply circuit 23, zener diode 231, light-emitting assembly 24, control chip 241, LED chip 242, and PCB board 3.

### DETAILED DESCRIPTION OF THE INVENTION

The technical solution in the embodiments of this invention will be clearly and completely described below with reference to the attached drawings. The described embodiments are illustrative only and do not represent all embodiments of this invention. Based on the embodiments of this invention, all other embodiments obtained by ordinary persons skilled in the art without inventive efforts shall also fall within the protection scope of this invention.

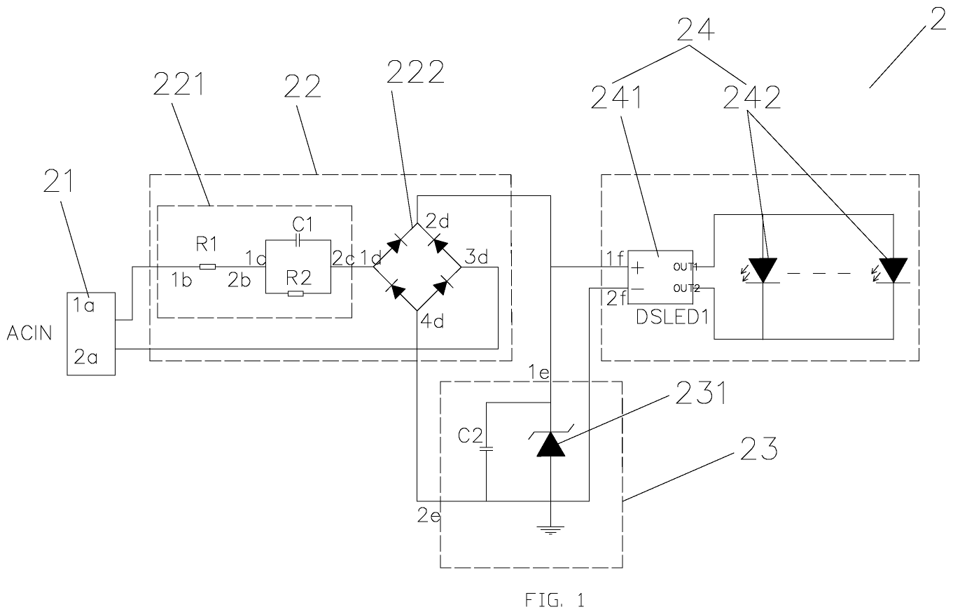

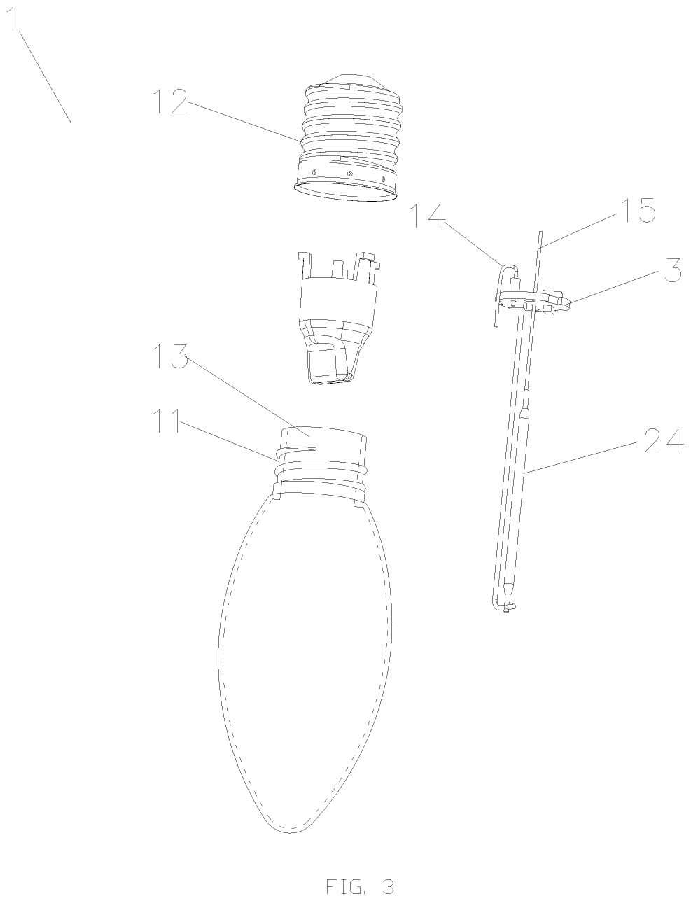

As shown in FIGS. 1 to 3:

An LED lamp with a good dynamic effect comprises a lamp body 1 and a photoelectric circuit 2 arranged in the lamp body 1.

The lamp body 1 comprises a lampshade 11 and a lamp holder 12 connected with the lampshade 11. The lampshade 11 and the lamp holder 12 are connected with each other to form an empty cavity 13 inside. The photoelectric circuit 2 is installed in the empty cavity 13. The lamp body 1 is provided with a first power supply end 14 and a second power supply end 15. The lampshade 11 is a light-transmitting plastic lampshade, which is beneficial to improving the drop resistance of the lamp and avoids the use of open flames in the production process.

For convenience of description, an upper portion of the lamp body 1 is defined to be in a direction where the lamp holder 12 is located, and a lower portion of the lamp body 1 is defined to be in a direction where the lampshade 11 is located.

The photoelectric circuit 2 comprises a power supply input end 21 (ACIN), an alternating current/direct current (AC TO DC) management circuit 22, a light-emitting power supply circuit 23 and a light-emitting assembly 24.

The power supply input end 21 has a first end 1a (i.e., the first power supply end 14) and a second end 2a (i.e., the second power supply end 15). The first end 1a and the second end 2a together form a power supply end of the lamp body 1, and the power supply end is connected with an external power supply. In this embodiment, the power supply end can input an alternating current power supply or a direct current power supply to supply power to the present invention. The alternating current power supply is a conventional power supply, such as mains power, and the direct current power supply is a conventional power supply, which will not be described in detail herein.

The alternating current/direct current (AC TO DC) management circuit 22 comprises a resistance-capacitance step-down assembly 221 and a rectifier 222. The resistance-capacitance step-down assembly 221 comprises a resistor R2 and a capacitor C1 connected in parallel with each other, and a resistor R1 connected in series therewith.

The rectifier 222 has a first rectifier end 1d, a second rectifier end 2d, a third rectifier end 3d, and a fourth rectifier end 4d. The rectifier 222 is a conventional rectifier in the art.

The first end 1a of the power supply input end 21 is electrically connected with a first end 1b of the resistor R1, and the second end 2a of the power supply input end 21 is electrically connected with the third rectifier end 3d; a second end 2b of the resistor R1 is electrically connected with a first end 1c of the parallel connected resistor R2 and capacitor C1, and a second end 2c of the parallel connected resistor R2 and capacitor C1 is electrically connected with the first rectifier end 1d. The alternating current/direct current (AC TO DC) management circuit 22 divides voltage through the resistance-capacitance step-down assembly 221, and the rectifier 222 converts alternating current mains power into a low-voltage direct current and supplies power to the light-emitting assembly 24 so as to adapt to the light-emitting assembly 24 with higher voltage, so that the light-emitting effect of the present invention is ensured.

The light-emitting power supply circuit 23 comprises a capacitor C2 and a zener diode 231 connected in parallel with each other, and the light-emitting power supply circuit 23 has a first end 1e and a second end 2e. The first end 1e of the light-emitting power supply circuit 23 is electrically connected with the second rectifier end 2d, and the second end 2e of the light-emitting power supply circuit 23 is electrically connected with the fourth rectifier end 4d. The light-emitting power supply circuit 23 can filter out high-frequency signals through the capacitor C2, and the zener diode 231 can stabilize the operating voltage of the light-emitting assembly 24.

The light-emitting assembly 24 internally comprises a control chip 241 and a plurality of LED chips 242 connected with each other. The control chip 241 is a program for programmably driving the plurality of LED chips 242 to emit light. The plurality of LED chips 242 are connected with the control chip 241 and packaged into a long strip-shaped lamp filament, and the length of the long strip-shaped lamp filament corresponds to the size of the empty cavity 13 formed inside the lamp body 1. The light-emitting assembly 24 is a surface mount LED lamp already available in the market, and the specific number of the LED chips 242 is set according to the actual situation, which will not be limited herein. The long strip-shaped lamp filament arranged in the limited space of the lamp body 1 has a good light-emitting effect.

The light-emitting assembly 24 has a first end 1f and a second end 2f. The first end 1f of the light-emitting assembly 24 is electrically connected with the second rectifier end 2d, and the second end 2f of the light-emitting assembly 24 is electrically connected with the fourth rectifier end 4d. Further, in this embodiment, the first end 1f of the light-emitting assembly 24 and the second end 2f of the light-emitting assembly 24 are conventionally set according to the actual circuit loop, which will not be described in detail herein.

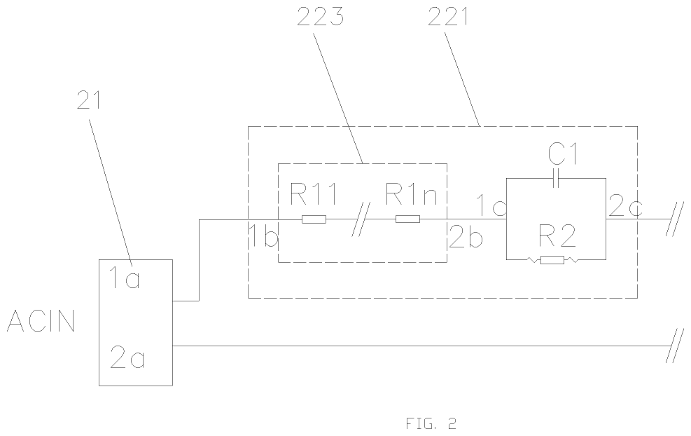

As shown in FIG. 2:

The lamp body 1 is internally provided with a PCB board 3. The power supply input end 21 (ACIN), the alternating current/direct current (AC TO DC) management circuit 22, the light-emitting power supply circuit 23 and the light-emitting assembly 24 of the photoelectric circuit 2 are arranged on the PCB board 3.

Preferably, the alternating current/direct current (AC TO DC) management circuit 22 comprises at least one resistor R1. If there is one resistor R1, two ends of the resistor R1 are respectively connected with the first power supply end 14 and the first end 1c of the parallel connected resistor R2 and capacitor C1 described above. As shown in FIG. 2, the resistor R1 may also be a resistor assembly 223 comprising at least two sequentially connected resistors which are respectively resistor R11, resistor R12, . . . , resistor R1n, where n is a positive integer greater than 1, and the resistors R11 . . . . R1n are sequentially connected, that is, a first end 1b of the resistor R11 is connected with the first power supply end 14, a second end 2b of the resistor R11 is connected with a first end 1b of the resistor R12, and so on, and a second end 2b of the resistor R1n is electrically connected with the first end 1c of the parallel connected resistor R2 and capacitor C1. It should be noted that the number and resistance of the resistors R1 are set according to the installation space, the installation method, and the condition of the light-emitting assembly 24 inside the actual lamp body 1, and the setting is realized by the conventional technical means in the art so as to preferably ensure the light-emitting effect of the light-emitting assembly 24, and also ensure that the resistor assembly 223 adapts to the installation space inside the lamp body 1.

It should be noted that the photoelectric circuit 2 is electrically connected as described in this embodiment, and the power supply input end 21 (ACIN), the alternating current/direct current (AC TO DC) management circuit 22, the light-emitting power supply circuit 23 and the light-emitting assembly 24 can be connected through a lead circuit of the PCB board 3, so as to form a complete circuit loop.

In addition, the production process of the present invention can be the same as the production process of the lamp which has been applied by the Applicant, for example, the production process in the Chinese utility model patent entitled “A NOVEL LED LAMP” with the application number of “202223472540.9”.

In this embodiment, the photoelectric circuit 2 is arranged in the lamp body 1 having the surface mount LED, and specifically, the electronic components in the photoelectric circuit 2 are installed in the lamp body 1; in this way, each electronic component in the photoelectric circuit 2 adapts to the internal space of the lamp body 1, the long strip-shaped lamp filament can be installed in the limited space of the lamp body 1; the long strip-shaped lamp filament is formed by at least one LED chip 242, and the voltage of each LED chip 242 is relatively high, so that the light efficiency of the lamp is high, and the space occupied by the LED chip 242 and the components in the photoelectric circuit 2 is as compact as possible, so as to adapt to the limited volume of the lamp body 1.

By adopting the design solution described above, the present invention has the following beneficial effects: The voltage division is realized through the resistance-capacitance step-down assembly 221, the rectifier 222 converts alternating current mains power into a low-voltage direct current and supplies stabilized voltage power to the light-emitting assembly 24 through the capacitor C2 and the zener diode 231 connected in parallel with each other, the capacitor C2 can filter out high-frequency signals, and the zener diode 231 can stabilize the operating voltage of the light-emitting assembly 24, so that the LED chip 242 in the long strip-shaped lamp filament is programmed to light up. In the present invention, the carrier technology is adopted to realize the carrier modulation of signals and power supply and the power line carrier data transmission, and step-by-step delivery and step-by-step control can be performed, so that the meteor light effect of the present invention can be ensured while the photoelectric circuit is installed in the limited space of the lamp body.

Although embodiments of the present invention have been illustrated and described, it should be understood that changes, modifications, substitutions, and alterations can be made to such embodiments by those of ordinary skills in the art without departing from the principle and spirit of the present invention, and the scope of the present invention is limited by the appended claims and equivalents.

What is claimed is:

1. An LED lamp with a good dynamic effect comprises a lamp body and a photoelectric circuit; an empty cavity is formed inside the lamp body; the photoelectric circuit is installed in the empty cavity; wherein, the photoelectric circuit comprises a power supply input end, an alternating current/direct current management circuit, a light-emitting power supply circuit and a light-emitting assembly; the alternating current/direct current management circuit comprises a resistance-capacitance step-down assembly and a rectifier;
the power supply input end has a first power supply end and a second power supply end; the resistance-capacitance step-down assembly has a first resistance-capacitance step-down assembly end and a second resistance-capacitance step-down assembly end; the rectifier has a first rectifier end, a second rectifier end, a third rectifier end and a fourth rectifier end; the light-emitting power supply circuit has a first light-emitting power supply circuit end and a second light-emitting power supply circuit end; the light-emitting assembly has a first light-emitting assembly end and a second light-emitting assembly end;
the first power supply end is electrically connected with the first resistance-capacitance step-down assembly end; the second power supply end is electrically connected with the third rectifier end; the second resistance-capacitance step-down assembly end is electrically connected with the first rectifier end; the first light-emitting power supply circuit end is electrically connected with the second rectifier end; the second light-emitting power supply circuit end is electrically connected with the fourth rectifier end; the first light-emitting assembly end is electrically connected with the second rectifier end; the second light-emitting assembly end is electrically connected with the fourth rectifier end;
the lamp body is internally provided with a PCB board; the power supply input end, the alternating current/direct current management circuit, the light-emitting power supply circuit and the light-emitting assembly are respectively arranged on the PCB board.

2. The LED lamp with a good dynamic effect of claim 1, wherein the light-emitting assembly internally comprises a control chip and a plurality of LED chips connected with each other; the control chip is a program for programmably driving the plurality of LED chips to emit light; the plurality of LED chips are connected with the control chip and packaged into a long strip-shaped lamp filament, and the long strip-shaped lamp filament has a length which corresponds to size of the empty cavity formed inside the lamp body.

3. The LED lamp with a good dynamic effect of claim 1, wherein the resistance-capacitance step-down assembly comprises a resistor R2 and a capacitor C1 connected in parallel with each other.

4. The LED lamp with a good dynamic effect of claim 3, wherein the resistance-capacitance step-down assembly further comprises a resistor R1; the resistor R1 is connected in series with the parallel connected resistor R2 and capacitor C1.

5. The LED lamp with a good dynamic effect of claim 1, wherein the light-emitting power supply circuit comprises a capacitor C2 and a zener diode connected in parallel with each other.

6. The LED lamp with a good dynamic effect of claim 1, wherein the first power supply end and the second power supply end together form a power supply end of the lamp body, and the power supply end is connected with an external power supply.

7. The LED lamp with a good dynamic effect of claim 4, wherein the resistor R1 is a resistor assembly comprising at least two sequentially connected resistors R1.

8. The LED lamp with a good dynamic effect of claim 1, wherein the lamp body comprises a lampshade and a lamp holder connected with the lampshade; the empty cavity is formed in the lamp body when the lampshade and the lamp holder are connected with each other.

9. The LED lamp with a good dynamic effect of claim 8, wherein the PCB board is installed in an upper portion of the empty cavity; the power supply input end, the alternating current/direct current management circuit, the light-emitting power supply circuit and the light-emitting assembly of the photoelectric circuit are arranged on the PCB board.
